(19) United States
(12) Patent Application Publication
(10) Pub. No.: US 2001/0008222 A1
(43) Pub. Date: Jul. 19, 2001

(54) CYCLODEXTRIN POLYMER SEPARATION MATERIALS

(76) Inventors: MIN MA, ARIZONA AVENUE LOS ALAMOS, NM (US); DEQUAN LI, LOS ALAMOS, NM (US)

Correspondence Address: BRUCE H COTTRELL, LOS ALAMOS NATIONAL LABORATORY, PO BOX 1663 MS D412, LOS ALAMOS, NM, 87545

(21) Appl. No.: 09/214,216

(22) PCT Filed: Nov. 21, 1997
(86) PCT No.: PCT/US97/21784

§ 371 Date: None

(51) Int. Cl. B01D 24/00; C08G 18/06

(52) U.S. Cl. 210/767; 528/73; 528/272; 536/103; 210/807; 527/300

(57) ABSTRACT

A water insoluble polymeric composition which is a reaction product of a cyclodextrin monomer and a polyfunctional crosslinker from the group of polyisocyanates, dihalohydrocarbons, and dihaloacetylhydrocarbons is disclosed together with a process for removing a target organic compound from an aqueous composition including contacting the aqueous composition containing a target organic compound with a water insoluble cyclodextrin polymer which is the reaction product of a cyclodextrin monomer and a polyfunctional crosslinker from the group of polyisocyanates, dihalohydrocarbons, and dihaloacetylhydrocarbons for time sufficient to form a reaction product between the water insoluble cyclodextrin polymer and the target organic compound whereby the concentration of the target organic compound in the aqueous composition is reduced. Organic chromophores added to the water insoluble cyclodextrin polymers can provide organic nonlinear optical materals.

This application claims the benefit of U.S. Provisional Application No. 60/031,645 filed Nov. 22, 1996.

### FIELD OF THE INVENTION

The present invention relates to cyclodextrin polymer materials and to the use of such cyclodextrin polymer materials as separation materials for separation or removal of, e.g., organic contaminants from aqueous compositions. More particularly, the present invention relates to water insoluble cyclodextrin polymer materials. This invention is the result of a contract with the Department of Energy (Contract No. W-7405-ENG-36).

### BACKGROUND OF THE INVENTION

Various cyclodextrin polymers are known. Cserhati et al., Anal. Chim. Acta, vol. 279, pp. 107-113, 1993, describe monomer β-cyclodextrin polymerized on the surface of silica particles for use in a liquid chromatographic column and the retention characteristics of such a column with various ring-substituted phenol derivatives. Cserhati, Anal. Chim. Acta, vol. 292, pp. 17-22, 1994, describes a water insoluble β-cyclodextrin polymer formed by crosslinking β-cyclodextrin monomers with epichlorohydrin and ethyleneglycolbis(epoxypropyl ether). The resultant polymer was ground into a powder and thin layer chromatography plates were prepared with the powder. Binding properties of this β-cyclodextrin polymer with various esters of 3,5-dinitrobenzoic acid were studied. Kutner, Electrochimica Acta, vol.37, no. 6, pp. 1109-1117, 1992, describes α-cyclodextrin polymer films formed by crosslinking of a soluble α-cyclodextrin polymer (partially crosslinked with 1-chloro-2,3-epoxypropane) with glutaric aldehyde. The polymer films were studied in conjunction with a 4-nitrophenol/4-nitrophenolate guest system. Zhao et al., Reactive Polymers, vol. 24, pp. 9-16, 1994, describe β-cyclodextrin immobilized onto crosslinked styrene/divinylbenzene copolymer to form a β-cyclodextrin polymeric adsorbent. This adsorbent demonstrated apparent inclusion ability for isomeric compounds such as 2- and 4-nitro-substituted aromatic compounds, e.g., 2-nitrophenol, 4-nitrophenol and 2,4-dinitrophenol.

Additionally, the use of cyclodextrin derivatives for adsorption or extraction of certain organic materials is known. For example, U.S. Pat. No. 5,190,663 uses cyclodextrin anchored to a water insoluble substrate or carrier particle to remove dissolved polynuclear aromatic hydrocarbons from an aqueous composition. U.S. Pat. No. 5,425,881 uses aqueous solutions of cyclodextrins or cyclodextrin derivatives in extraction of an organic pollutant from contaminated soil and also describes water soluble cyclodextrin polymers wherein the cyclodextrin is crosslinked with epichlorohydrin or isocyanate.

Despite the previous work in the areas of cyclodextrin polymers and use of cyclodextrin materials for adsorption or extraction of organic pollutants, the area remains open to continued developments that can open up further opportunities.

It is an object of the present invention to provide water insoluble cyclodextrin polymer materials.

Another object of the invention is to provide water insoluble cyclodextrin polymer materials having a defined nanoporous structure.

It is a further object of the invention to provide separation materials of water insoluble cyclodextrin polymers for the separation of selected target organic compounds, e.g., organic pollutants or contaminants, from aqueous compositions.

It is a still further object of the invention to provide a process for separating target organic compounds, e.g., organic pollutants or contaminants, from an aqueous composition by contact with the presently disclosed water insoluble cyclodextrin polymer materials.

### SUMMARY OF THE INVENTION

To achieve the foregoing and other objects, and in accordance with the purposes of the present invention, as embodied and broadly described herein, the present invention provides a water insoluble polymeric composition comprising a reaction product of a cyclodextrin monomer and a polyfunctional crosslinker selected from the group consisting of polyisocyanates, dihalohydrocarbons, and dihaloacetylhydrocarbons.

The present invention further provides a process for removing a target organic compound from an aqueous composition comprising contacting said aqueous composition containing a target organic compound with a water insoluble cyclodextrin polymer comprising a reaction product of a cyclodextrin monomer and a polyfunctional crosslinker selected from the group consisting of polyisocyanates, dihalohydrocarbons, and dihaloacetylhydrocarbons for time sufficient to form a reaction product between said water insoluble cyclodextrin polymer and said target organic compound whereby the concentration of said target organic compound in said aqueous composition is reduced.

### BRIEF DESCRIPTION OF THE DRAWINGS

FIG. 1 is a graph showing induced circular dichroism of a cyclodextrin polymer complex with para-nitrophenol.

FIG. 2 is a graph showing a second harmonic generation signal versus incident angle.

FIG. 3 is a graph showing estimation on pore size by plotting actual loading of various organic materials having varying critical or maximum dimensions.

### DETAILED DESCRIPTION

The present invention is concerned with cyclodextrin polymers and to the use of such cyclodextrin polymers as separation materials for separating selected organic materials from aqueous streams or compositions.

The cyclodextrin polymers of the present invention are generally formed by the reaction of a suitable cyclodextrin monomer with a polyfunctional crosslinking agent. The crosslinking agent may generally be an aromatic, an aliphatic or a cycloaliphatic polyfunctional crosslinking agent. Suitable polyfunctional crosslinking agents can include diisocyanates, polyisocyanates, dihalohydrocarbons, and dihaloacetylhydrocarbons. In addition, the polyfunctional crosslinking agent of the present invention can include asymmetric crosslinking agents containing different linking functionalities from among the functionalities of isocyanate, halo, or haloacetyl, on the linking molecule, e.g., at the ends of the molecule. An example of such a suitable asymmetric crosslinking agent may be 4-isocyanatobenzoyl chloride and the like. Preferably, the polyfunctional crosslinking agents include at least one isocyanate group or functionality.

The cyclodextrin polymers of this invention are characterized as water insoluble. The term “water insoluble” is a relative term and as used herein generally refers to materials having a solubility in water of no greater than about 0.01 grams per gram of water. Further, the cyclodextrin polymers of this invention can have a nanoporous structure capable of absorbing selected target organic compounds from within aqueous streams, solutions or compositions down to levels as low as parts per billion (ppb) and even to levels of parts per trillion (ppt).

Diisocyanates can include such as 2,6-tolylene diisocyanate, 2,4-tolylene diisocyanate (TDI), 4,4′-diphenylmethane diisocyanate (MDI), hexamethylene diisocyanate (HDI), and the like.

Dihalohydrocarbons can be generally represented by the formula X-R¹-X where X is a halogen selected from among chlorine, bromine and iodine, preferably chlorine, and R¹ is an alkylene group such as propylene, butylene, pentylene, hexylene, heptylene, octylene and the like, an alkylaryl group such as dimethylenebenzene, dipropylenebenzene and the like. Specific examples of suitable dihalohydrocarbons may include 1,3-dichloropropane, 1,3-dibromopropane, 1,3-diiodopropane, 1,6-dichlorohexane, 1,6-dibromohexane, 1,6-diiodohexane, 1,8-dichlorooctane, 1,8-dibromooctane, 1,8-diiodooctane, 1,4-chloromethylenebenzene, 1,4-bromomethylenebenzene, and 1,4-iodomethylenebenzene.

Dihaloacetylhydrocarbons can be generally represented by the formula XOC-R²-COX where X is a halogen selected from among chlorine, bromine and iodine, preferably chlorine, and R² is an alkylene group such as propylene, butylene, pentylene, hexylene, heptylene, octylene and the like, an alkylaryl group such as dimethylenebenzene, dipropylenebenzene and the like. Suitable dihaloacetylhydrocarbons may be generally prepared by chlorination of dibasic acids such as dicarboxylic acids and specific examples of dicarboxylic acids may include 1,4-butanedicarboxylic acid (adipic acid), ortho-benzene dicarboxylic acid (oxalic acid), cis-butenedioic acid (maleic acid), and decanedioic acid (sebacic acid).

Suitable cyclodextrin monomer materials include α-cyclodextrin, β-cyclodextrin, γ-cyclodextrin or substituted α-cyclodextrins, substituted β- cyclodextrins, or substituted γ-cyclodextrins, preferably substituted α-cyclodextrins, substituted β-cyclodextrins, or substituted γ-cyclodextrins. Generally, cyclodextrins are linked D-glucopyranose units, with α-cyclodextrin, β-cyclodextrin, γ-cyclodextrin being composed of 6, 7, or 8 units, respectively, the units linked into a circular arrangement. Accordingly, the internal diameter of each of α-cyclodextrin, β-cyclodextrin, γ-cyclodextrin varies from the others. α-cyclodextrin has a cavity size or internal diameter of about 4.7 to 5.2 Angstroms (A), β-cyclodextrin has an internal diameter of about 6.0 to 6.5A, and γ-cyclodextrin has an internal diameter of about 7.5 to 8.5A. Branched cyclodextrin monomer materials may also be employed.

The term “substituted cyclodextrin” refers to a cyclodextrin modified by the addition of other functional groups, e.g., a cyclodextrin wherein a hydrogen atom of one or more primary or secondary hydroxyl groups therein has been substituted by, e.g., a carboxyl group, a carboxyl alkyl group, a carboxylaryl group, an alkyl group, e.g., either a lower alkyl such as a C₁ to C₄ group, i.e., methyl, ethyl, propyl or butyl, or a longer chain aliphatic containing from about 8 to about 22 carbons, a hydroxyalkyl group, a sulfonic group, or an alkylenesulfonic group and the like. Modification of a cyclodextrin can alter the length and size of the internal cavity or alter the chemical compatibility or binding properties of the particular substituted cyclodextrin with a target organic compound.

One manner of preparing a substituted cyclodextrin polymer may be to modify or fuctionalize a cyclodextrin monomer prior to polymerization of the monomer. Another manner of preparing a substituted cyclodextrin polymer may be to polymerize a cyclodextrin monomer and then to modify or functionalize the resultant cyclodextrin polymer. Preferably, the substituted cyclodextrin monomer is prepared prior to polymerization of the substituted cyclodextrin monomer. One benefit of tailoring the substituted cyclodextrin functionality may be to alter the retention times of the particular target organic species.

The process of the present invention is characterized by the feature that the initial concentration of the target organic compounds in the aqueous composition is generally relatively low and the final concentration of the target organic compounds after treatment with the cyclodextrin polymers of the present invention is extremely low.

The cyclodextrin polymers and the substituted cyclodextrin polymers of the present invention have been found to be selective for the target organic compounds and can generally effect essentially complete removal of such target organic compounds contained within a sample of water so long as the concentration of organic compounds is not so great to exceed the amount of cyclodextrin polymer material used.

In the process of the present invention, an aqueous composition including a relatively low concentration of target organic compounds is contacted with a water insoluble cyclodextrin polymer comprising the reaction product of a cyclodextrin monomer and a polyfunctional crosslinker selected from among polyisocyanates, dihalohydrocarbons, and dihaloacetylhydrocarbons. Asymmetrical crosslinkers may also be employed. Typically, the process is carried out under conditions such as at temperatures and for periods of time sufficient to reduce the amount of target organic compounds to a preselected level. The entire operation can be carried out at ambient conditions in which case complexation of the target organic compounds is fairly rapid, and contact times between the water insoluble cyclodextrin polymer and the aqueous composition can be as short as about five seconds or less. Increasing the contact time has no detrimental effect on the process and may in fact increase removal efficiency of the target organic compounds. There is a tradeoff between the process conditions and the amount of water insoluble cyclodextrin polymer used. There is a general stoichiometric reaction between cyclodextrins and target organic compounds. The reaction is first order, i.e., the rate correlates with concentration and surface area. Increasing the surface area or organic concentration will increase reaction rate. Increasing temperature will also increase the reaction rate of removal of organics. Thus, if complexation is inhibited by rapid contact rates, high temperatures or when purifying an aqueous stream containing high hydrocarbon levels, increasing the amount of water insoluble cyclodextrin polymer generally increases removal efficiency of the target organic compounds.

The process of the present invention can be conducted by using a powder of the water insoluble cyclodextrin polymer where such powder is supported in a packed column, cartridge, or bed through which the aqueous composition is passed at a suitable rate to effect removal of the target organic compounds. In another embodiment of the process of the invention, a larger piece (as opposed to a powder) of the water insoluble cyclodextrin polymer, e.g., a piece having dimensions of at least about one quarter inch by about one quarter inch by about one quarter inch, or a spherical piece having a diameter of at least about one quarter inch, can be placed in contact with a quantity of water containing a undesirable amount of the target organic compounds. The specific size of the larger piece is not critical and smaller pieces, greater than a typical powder, can be used singly or in combination with other small pieces to extract target organic compounds from a water sample such as a well and the like. Generally, such an undesirable amount of the target organic compounds is an amount exceeding some defined level such as levels set by agencies such as the United States Environmental Protection Agency (EPA). Generally, the concentration of the target organic compounds will normally be reduced to a level which is prescribed for such pollutants or to a level lower than present conventional detection limits. In yet another embodiment of the process of the invention, a thin film of the water insoluble cyclodextrin polymer can be formed on a support substrate such as a glass substrate, or on beads, and the supported thin film of the water insoluble cyclodextrin polymer contacted with the aqueous stream including the target organic compounds. Such a thin film can typically be of a thickness from about 0.01 microns to about 5 millimeters. Hollow fibers of the cyclodextrin polymer may also be employed.

After separation of the target organic compounds from an aqueous composition by the water insoluble cyclodextrin polymer, the target organic compounds can be separated from the water insoluble cyclodextrin polymer by extraction with a suitable extraction agent or solvent. Suitable extraction agents or solvents can include alcohols such as methanol, ethanol and the like.

Among the various organic compounds that can be target materials for removal from aqueous streams are included aromatic compounds, e.g., benzene, toluene, xylene and the like, polyaromatic compounds including compounds with fused ring structures containing between about two and ten rings, some or all of which are benzene rings, e.g., naphthalenes, indenes, anthracenes, phenanthrenes, fluorenes, acenaphthenes, benzanthracenes, perylenes, tetracenes, pyrenes, benzopyrenes, benzoperylenes, and the like, oxygen-containing organic compounds, e.g., methanol, acetone, dimethyl sulfoxide, dimethyl formamide, tetrahydrofuran and the like, halogenated, e.g., brominated or chlorinated, hydrocarbons, e.g., chloroform, carbon tetrachloride, methylene chloride, trichloroethane, tetrachloroethene, dichloroethylene, trichloroethylene, and the like, and nitro-containing compounds, e.g., para-nitrophenol, nitrobenzene, dinitrobenzene, trinitrobenzene, hexanitrobenzene, nitrotoluene, dinitrotoluene and the like. Clean-up of explosive materials may be carried out with the polymer materials of this invention as such explosive materials are generally nitro-containing organic compounds.

The ability of the present cyclodextrin polymers to serve as separation materials can be compared with other conventional separation type materials such as activated carbon and zeolites (molecular sieves). The following table shows a comparison of a diisocyanate crosslinked β-cyclodextrin polymer with para-nitrophenol as the target organic.

TABLE 1

| | Type of separation material | | |
|---|---|---|---|
| | | | zeolite |
| characteristic of separation material | CD polymer | activated carbon | (3A) |
| Pore diameter (Å)* | 7-9 | — | 3 |
| Surface area (square meters per gram) | 1.7-1.9 | 750 | — |
| Binding (Formation) constants with | 6.9 × 10⁹ M⁻¹ | 1.4 × 10⁴ M⁻¹ | ≈0.0 M⁻¹ |
| organic material | | | |
| Total absorbance of organic material | 22 mg/gram | 58 mg/gram | ≈0.0 |
| (Loading level) | | | |
| Effective clean-up limits in water | ≈3.0 ppt | ≈1.3 ppm | — |
| (equilibrium concentration) | | | |
| Leachability of organic material in water | No | Yes | Yes |
| Formability into a thin film or | Yes | No | No |
| membrane | | | |
| Absorption of water in air | No | 19.6 mg/hr.g | Yes |

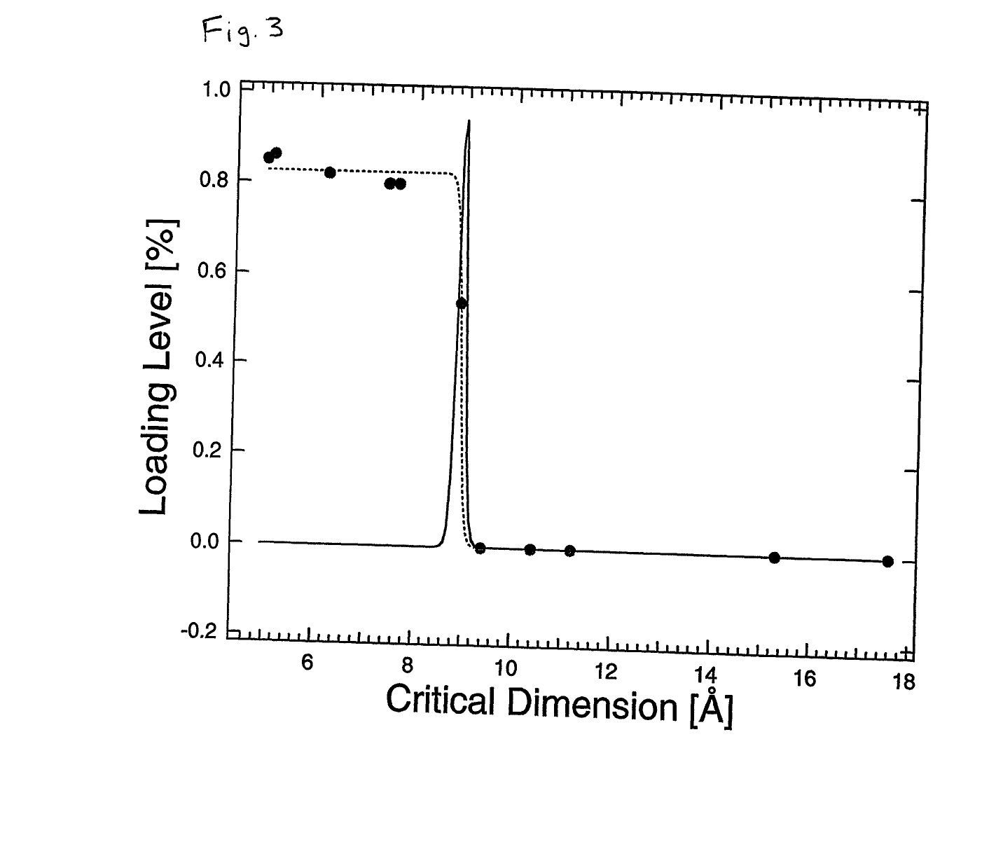

*FIG. 3 shows the plot of the critical dimension (largest) of various sized organic materials against loading of the cyclodextrin polymer with an estimation of pore size based on the size of the organic materials actually loaded into the polymer.

It can be seen that the cyclodextrin polymer can lower the concentration of some organic materials to as low as about 3 parts per trillion (ppt), far lower than a conventional separation material of activated carbon at about 1.3 parts per million (ppm). Activated carbon is often used in typical pump and treat systems for groundwater contamination. While activated carbon has a higher loading capacity at 58 milligrams per gram than the cyclodextrin polymer, the activated carbon can be leached by additional water to contaminate further water whereas the cyclodextrin polymer will bind the target organic until eluation with some non-aqueous solvent such as ethanol.

In addition to the use of the present water insoluble cyclodextrin polymers as separation materials for selected organic compounds, it has been found that the reaction product (often referred to as a complexation product) of certain organic compounds with the water insoluble cyclodextrin polymer can have nonlinear optical properties such that the reaction product can be characterized as an organic nonlinear optical material. Optical quality thin films can be prepared from the water insoluble cyclodextrin polymers of the present invention. Such thin films can then absorb organic chromophores from water. Some chromophores can be nonlinear optical materials, typically for polar molecules. Among suitable chromophores may be included 4-nitrophenol, 4-nitrostyryl-4′-phenol, 4-hydroxylstilbazole, and 4-hydroxylstilbazolium iodide. Such polar molecules will have a preferential orientation inside the cavity of a cyclodextrin material since the polar nature of the water-polymer interface will generally cause the chromophore to orient prior to entering the polymeric matrix. Then, once the chromophore enters the solid cyclodextrin polymer material, the chromophores retain the alignment and can possess second order nonlinear optical properties. Organic nonlinear optical materials offer potential for use in integrated optical devices.

The present invention is more particularly described in the following examples which are intended as illustrative only, since numerous modifications and variations will be apparent to those skilled in the art.

### EXAMPLE 1

To 2.0 grams (g) of dried β-cyclodextrin (β-CD) in 10 milliliters (ml) of dried dimethylformamide (DMF), 1,6-diisocyanatohexane (HDI) was added dropwise with vigorous stirring. The total volume of HDI added was 2.5 ml. Under a nitrogen atmosphere, the solution was heated at 80° C. for 16 hours. A polymeric material was then recovered from the solution as a clear, transparent solid. Residual DMF was removed by heating under vacuum at 80° C. for 24 hours. The resultant product was a polymeric cyclodextrin solid which could easily be ground into a powder.

### EXAMPLE 2

To 2.0 g of dried α-cyclodextrin (α-CD) in 10 ml of dried DMF, 1,6-diisocyanatohexane (HDI) was added dropwise with vigorous stirring. The total volume of HDI added was 2.5 ml. Under a nitrogen atmosphere, the solution was heated at 80° C. for 16 hours. A polymeric material was then recovered from the solution as a clear, transparent solid. Residual DMF was removed by heating under vacuum at 80° C. for 24 hours. As in example 1, the resultant product was a polymeric cyclodextrin solid which could easily be ground into a powder.

### EXAMPLE 3

To 2.0 g of dried β-cyclodextrin (β-CD) in 10 ml of dried DMF, toluene 2,4-diisocyanate (TDI) was added dropwise with vigorous stirring. The total volume of TDI added was 2.5 ml. Under a nitrogen atmosphere, the solution was heated at 80° C. for 16 hours. A polymeric material was then recovered from the solution as a clear, transparent solid. Residual DMF was removed by heating under vacuum at 80° C. for 24 hours. As in example 1, the resultant product was a polymeric cyclodextrin solid which could easily be ground into a powder.

### EXAMPLE 4

To 2.0 g of dried α-cyclodextrin (α-CD) in 10 ml of dried DMF, toluene 1,6-diisocyanate (TDI) was added dropwise with vigorous stirring. The total volume of TDI added was 2.5 ml. Under a nitrogen atmosphere, the solution was heated at 80° C. for 16 hours. A polymeric material was then recovered from the solution as a clear, transparent solid. Residual DMF was removed by heating under vacuum at 80° C. for 24 hours. As in example 1, the resultant product was a polymeric cyclodextrin solid which could easily be ground into a powder.

### EXAMPLE 5

To 2.0 g of dried β-cyclodextrin (β-CD) in 10 ml of dried DMF, 1,6-diisocyanatodecane (DDI) was added dropwise with vigorous stirring. The total volume of DDI added was 2.5 ml. Under a nitrogen atmosphere, the solution was heated at 80° C. for 16 hours. A polymeric material was then recovered from the solution as a clear, transparent solid. Residual DMF was removed by heating under vacuum at 80° C. for 24 hours. As in example 1, the resultant product was a polymeric cyclodextrin solid which could easily be ground into a powder.

The reactivity of the bi-functional linkers, i.e., the HDI, TDI and DDI was observed to be: TDI>HDI>DDI. The hydrophobicity of the resulting cyclodextrin polymers varied with the bi-functional linker with DDI>HDI>TDI. In each of example 1-5, infrared measurements indicated that the isocyanato groups had disappeared and peaks corresponding to O—C═O, O═C—NH and NH groups were observed.

### EXAMPLE 6

A water solution, total volume 4.16 liters, containing about 3×10⁻⁹ moles per liter (M) of para-nitrophenol was passed through a glass column packed with 0.5858 g of powder of the cyclodextrin polymer from example 1. The powder gradually turned visibly yellow in color from its initial clear, colorless appearance. Retention of para-nitrophenol by the cyclodextrin polymer powder was confirmed. The final solution concentration of para-nitrophenol was measured as 1.44×10⁻¹⁰ M. The para-nitrophenol was then separated from the cyclodextrin polymer powder by washing of the cyclodextrin polymer powder with ethanol. The non-covalent binding of the para-nitrophenol to the cyclodextrin polymer powder allowed the separation of the para-nitrophenol from the cyclodextrin polymer powder by washing with an organic solvent such as ethanol.

Formation constants were calculated as 6.93×10⁻⁹ M⁻¹ for the HDI-β-CD/para-nitrophenol complex and as 1.64×10⁹ M⁻¹ for the TDI-β-CD/ para-nitrophenol complex.

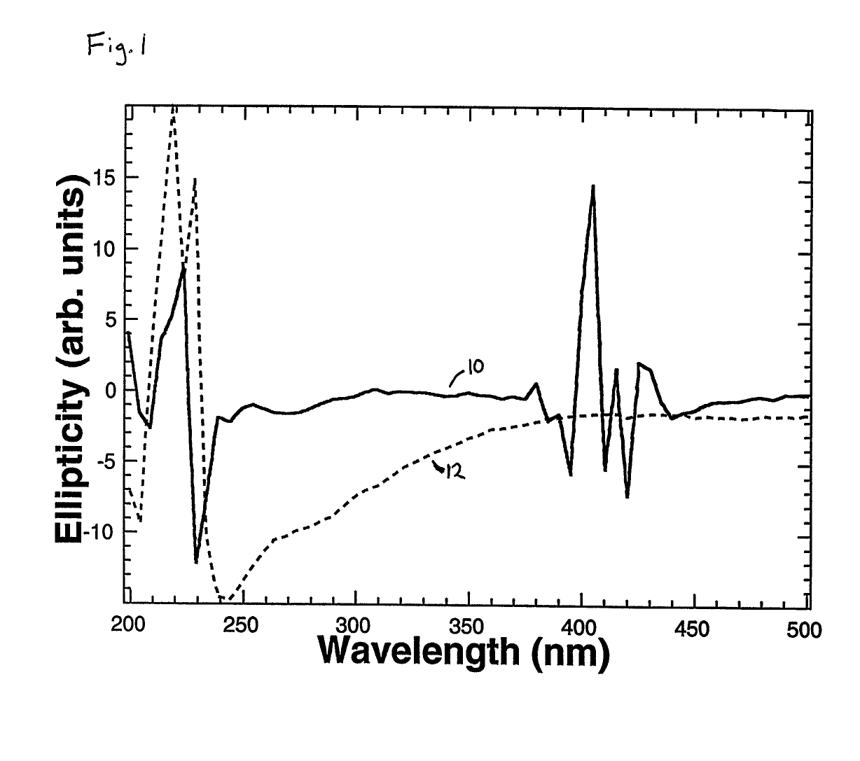

A sample of the resultant product between the HDI-β-CD and the para-nitrophenol was measured and contrasted with a sample of the HDI-β-CD. Measurements for induced circular dichroism are shown in FIG. 1 where solid line 10 shows the plot for the resultant product between the HDI-β-CD and the para-nitrophenol while dashed line 12 shows the plot for the sample of HDI-β-CD. The peak in line 10 at about 400 nanometers (nm) indicates the induced circular dichroism due to complex formation.

### EXAMPLE 7

A bulk portion of the polymer from example 1 was immersed in a one liter water solution containing about 2×10⁻⁷ M of para-nitrophenol for one day. The solid polymer (about 0.5 g) became visibly yellow after which it was removed from the solution. The final solution concentration of para-nitrophenol was measured as 1.8×10⁻¹⁰ M. The solid was then washed with ethanol whereupon para-nitrophenol was removed from the solid polymer until it again appeared clear and colorless.

### EXAMPLE 8

Synthesis of a substituted cyclodextrin was as follows. Dried β-cyclodextrin (1.3476 g; 1.187 mmole) was dissolved in 25 ml of dried DMSO. Sodium hydride (0.1996 g; 8.309 mmole) was added and the mixture was stirred at ambient temperature for 20 minutes. Then the mixture was cooled to 0° C. and 1.1797 ml (8.309 mmole) of methyl iodide was added dropwise over a period of 5 minutes. The mixture was stirred at room temperature for 24 hours. The excess of sodium hydride was decomposed by addition of 20 ml methanol. By pouring the solution into 200 ml of ice water, the product was precipitated from the solution and dried in vacuum for 24 hours.

### EXAMPLE 9

The methyl-substituted cyclodextrin was then polymeric with HDI as follows. The methyl substituted β-cyclodextrin monomer from example 8, i.e., CD-OCH₃

(0.5720 g; 0.4587 mmole), was dissolved in 10 ml of dried DMF. Hexane-diisocyanate (HDI) (1.10 ml; 3.67 mmole) was added dropwise to the solution. After the addition of HDI, the mixture was heated up to 85° C. and stirred for 2 days. The solvent was removed by distillation in vacuum for 1 day. The dried polymer product was grounded into powder.

### EXAMPLE 10

A measurement of the binding constant of the polymer from example 9 with toluene was conducted as follows. A standard solution of toluene in ethanol (2.345×10⁻³M) was prepared and calibrated by UV measurements. Absorbance was 0.973 at λ=262 nanometers (nm). Exactly 5 ml of this standard toluene solution was diluted to 1000 ml with water in order to obtain a toluene in water solution with a concentration of 4.6939×10−7 M.

Binding or equilibrium constant (K) measurements were as follows. The polymers (0.8292 g for the polymer of example 1 and 0.8751 gram for the polymer of example 9) were each immersed in 1000 ml of the aqueous toluene solution (4.6939×10⁻⁷ M) and stirred for 1 day. The final toluene concentration in the water was 8.85×10⁻⁹ M for the polymer of example 1 and 3.76×10⁻⁹ M for the polymer of example 9, respectively. Then the polymer was filtered off and washed with ethanol. The volume of ethanol was concentrated to around 5 ml.

The equilibrium constants (K) were then calculated with use of the following formula.

K=1/[organic compound]M

The concentration of toluene was determined by subtracting the amount of the toluene in the polymer from the initial concentration. The amount of organic in the individual polymers was eluted from the polymer, concentrated in ethanol solution, and measured accurately by UV absorption. The following equilibrium constants were obtained:

| | example 1 polymer | example 9 polymer |
|---|---|---|
| Final Volume of ethanol | 3.9 ml | 4.6 ml |
| UV absorbance (A) | 0.049 | 0.042 |
| Equilibrium Constant | K = 1.13 × 10⁸ M⁻¹ | 2.66 × 10⁸ M⁻¹ |

### EXAMPLE 11

A measurement of the binding constant of the polymer from example 9 with trichloroethylene (TCE) was conducted as follows. Exactly 2 ml of TCE was added to 1000 ml of water in a separation funnel to make the saturated TCE-H₂O solution. This solution was diluted by taking 20 ml of this saturated water solution from the aqueous phase and diluting to 2000 ml. The TCE concentration of this water solution was calibrated against a standard solution of TCE-hexane using UV absorption at 218 nm. The final aqueous concentration of TCE was determined to be 7.589×10⁻⁸ M.

Binding or equilibrium constant (K) measurements were as follows. The polymers (0.8818 g for example 1 polymer; 0.8008 gram for example 9 polymer) were immersed in 2000 ml of the aqueous TCE solution (7.589×10⁻⁸ M) and stirred for 1 day. The final TCE concentration in the water was found to be 1.05×10⁻⁹ M for example 1 polymer and 1.58×10⁻¹⁰ M for example 9 polymer, respectively. The equilibrium constants (K) were then calculated as before. The concentration of trichloroethylene was determined by subtracting the amount of the trichloroethylene in the polymer from the initial concentration. The amount of organic in the individual polymers was eluted from the polymer, concentrated in ethanol solution, and measured accurately by UV absorption. The following equilibrium constants were obtained:

| | example 1 polymer | example 9 polymer |
|---|---|---|
| Concentration | 7.5892 × 10⁻⁸ M | 7.5892 × 10⁻⁸ M |
| of initial TCE solution | | |
| Final Volume of ethanol | 8.0 ml | 5.5 ml |
| UV absorbance (A) | 0.089 | 0.131 |
| Equilibrium constant | 9.52 × 10⁸ M⁻¹ | 6.32 × 10⁹ M⁻¹ |

### EXAMPLE 12

An optical quality thin film of a cyclodextrin polymer similar to example 1 was prepared as follows. A flat round aluminum plate (a diameter of 1.3 inches and a thickness of 0.125 inches) was placed in the bottom of a 30-ml Teflon® beaker having a diameter of 1.5 inches. Dried β-cyclodextrin (0.4084 g, 0.360 mmol) was dissolved in 10 ml of dried DMF. Hexane-diisocyanate (0.55 ml; 2.879 mmol) was added into the solution. After stirring, the clear solution was poured into the Teflon® beaker with the aluminum plate as the support for the polymeric film. Then the whole beaker was put into a glass container which had been pre-heated to 60° C. The container was kept in the oil bath at constant temperature 60° C. for 1 day. A transparent colorless film with the thickness around 1/16 inches was formed on the aluminum plate.

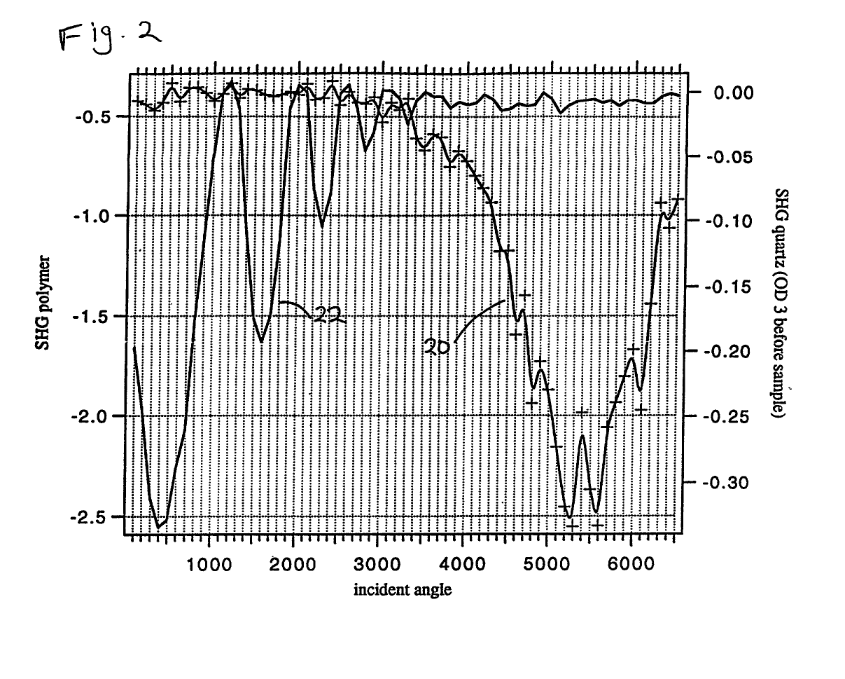

This optical quality film absorbed para-nitrophenol from a water solution. The para-nitrophenol served as an organic chromophore. These polar molecules are believed to have preferentially oriented themselves inside the cyclodextrin polymer because the polar nature of water-polymer interface causes the chromophore to orient before entering the polymeric matrix. FIG. 2 shows a graph illustrating the second harmonic generation measurement for a free-standing film of the para-nitrophenol complex or reaction product with the diisocyanate crosslinked cyclodextrin polymer. Line 20 shows the results for the para-nitrophenol-cyclodextrin polymer complex, while line 22 shows the results for a quartz reference. The results of these measurements demonstrate that chromophore-cyclodextrin polymer complexes can have second order nonlinear optical properties.

### EXAMPLE 13

Dried gamma-cyclodextrin (2.0 g) was added to 20 ml of dried DMF, then 1,6-diisocynatohexane (2.2 ml) was added dropwise with vigorous stirring. Under a nitrogen atmosphere, the solution was heated at 85° C. for 1 day. A polymeric material was then recovered from the solution as a clear, transparent solid. Residual DMF was removed by heating under vacuum at 80° C. for 24 hours. The resultant product was a polymeric cyclodextrin solid which can be easily ground into powder.

### EXAMPLE 14

A measurement of the binding constant of the polymer from example 1 with methyl-nitrophenol (MNP) was conducted as follows. MNP (0.0034 g) was dissolved in 100 ml deionized water, and diluted at 5000 times to make a 4.4404×10⁻⁸ M solution. Polymer from example 1 (0.5867 g) was added to 1000 ml of the above solution. After 1 day, the yellow polymer was filtered off and washed with ethanol.

| | |
|---|---|
| Initial concentration of MNP | 4.4404 × 10⁻⁸ M |
| Final volume of ethanol | 4.0 ml |
| UV absorbance (A) | 0.1702 |
| Equilibrium Constant (K) | 8.47 × 10⁸ M⁻¹ |

### EXAMPLE 15

Dimethyl-nitrophenol (DMNP) (0.0047 g) was dissolved in 250 ml deionized water and diluted 1000 times to make a 8.9974×10⁻⁹ M solution. Polymer from example 1 (0.6435 g) was added into 1000 ml of the above solution. After 1 day, the yellow polymer was filtered off and washed with ethanol.

| | |
|---|---|
| Initial concentration of DMNP | 8.9974 × 10⁻⁹ M |
| Final volume of ethanol | 3.8 ml |
| UV absorbance (A) | 0.01414 |
| Equilibrium Constant (K) | 1.53 × 10⁸ M⁻¹ |

### EXAMPLE 16

Hydroxybenzosulfunate (HBS) (0.0027 g) was dissolved in 500 ml deionized water and diluted 1000 times to make a 2.3257×10⁻⁸ M solution. Polymer from example 1 (0.6626 g) was added into 1000 ml of the above solution. After 1 day, the yellow polymer was filtered off and washed with ethanol.

| | |
|---|---|
| Initial concentration of DMNP | 2.3257 × 10⁻⁸ M |
| Final volume of ethanol | 4.0 ml |
| UV absorbance (A) | 0.1286 |
| Equilibrium Constant (K) | 4.23 × 10⁸ M⁻¹ |

Additional testing yielded the following data shown in Tables 2 and 3.

TABLE 2

| | CD-HDI | | | | | CD-TDI | Me-CD-HDI |
|---|---|---|---|---|---|---|---|
| | K | | Mass Load | Limit in | | K | K |
| Organics | (1/M) | Loading % | (mg) | water | | (1/M) | (1/M) |
| 4-Nitrophenol | 6.9 × 10⁹ | 86 | 22 | 3 | ppt | 2.2 × 10⁹ | |
| TCE | 9.5 × 10⁸ | 85 | 19 | 19 | ppt | | 6.3 × 10⁹ |
| Toluene | 1.1 × 10⁸ | 80 | 14 | 0.2 | ppb | | 2.7 × 10⁸ |
| Phenol | 8.0 × 10⁷ | 82 | 14 | 0.2 | ppb | | |

TABLE 3

| | | | Mass | | |
|---|---|---|---|---|---|
| | K | | Loading | Limit in | |
| Organics | (1/M) | Loading % | (mg) | Water | |
| Methyl-nitrophenol | 8.5 × 10⁸ | 82 | 23 | 21 | ppt |
| Dimethyl-nitro | 1.5 × 10⁸ | 82 | 25 | 0.1 | ppb |
| phenol | | | | | |
| 2-Nitro-1- | 1.1 × 10⁸ | 80 | 28 | 0.2 | ppb |
| naphthol | | | | | |
| 4-Nitrothio- | 2.7 × 10⁹ | 85 | 24 | 7 | ppt |
| phenol | | | | | |
| 4-Hydroxybenzene- | 4.2 × 10⁸ | 82 | 29 | 42 | ppt |
| sulfonic acid | | | | | |
| 4-Hydroxy-1- | ˜1 × 10⁸ | | | | |
| naphthalene- | (not stable) | | | | |
| sulfonic acid | | | | | |
| 1,3,6,8-Pyrene- | 7.0 × 10⁷ | 54 | 60 | 26 | ppb |
| tetra-sulfonic acid | | | | | |

Although the present invention has been described with reference to specific details, it is not intended that such details should be regarded as limitations upon the scope of the invention, except as and to the extent that they are included in the accompanying claims.

What is claimed is:

1. A water insoluble polymeric composition comprising a reaction product of a cyclodextrin monomer and a polyfunctional crosslinker selected from the group consisting of polyisocyanates, dihalohydrocarbons, and dihaloacetylhydrocarbons.

2. The water insoluble polymeric composition of claim 1 wherein said cyclodextrin monomer is selected from the group consisting of α-cyclodextrin, substituted α-cyclodextrin, β-cyclodextrin, substituted β-cyclodextrin, γ-cyclodextrin, and substituted γ-cyclodextrin.

3. The water insoluble polymeric composition of claim 1 wherein said polyfunctional crosslinker is a polyisocyanate.

4. The water insoluble polymeric composition of claim 3 wherein said polyisocyanate crosslinker is selected from the group consisting of aromatic diisocyanates and diisocyanatoalkanes.

5. The water insoluble polymeric composition of claim 1 wherein at least one hydroxyl group on said cyclodextrin monomer is substituted with an alkyl group to form one or more alkoxide groups.

6. A process for removing a target organic compound from an aqueous composition comprising:
contacting said aqueous composition containing a target organic compound with a water insoluble cyclodextrin polymer comprising a reaction product of a cyclodextrin monomer and a polyfunctional crosslinker selected from the group consisting of polyisocyanates, dihalohydrocarbons, and dihaloacetylhydrocarbons for time sufficient to form a reaction product between said water insoluble cyclodextrin polymer and said target organic compound whereby the concentration of said target organic compound in said aqueous composition is reduced.

7. The process of claim 6 wherein said water insoluble cyclodextrin polymer is contacted with said aqueous composition by passing said aqueous composition through a fixed bed of particles of said water insoluble cyclodextrin polymer.

8. The process of claim 6 wherein said water insoluble cyclodextrin polymer contacted with said aqueous composition is a solid with dimensions of at least about one quarter inch by one quarter inch by one quarter inch.

9. The process of claim 6 wherein said water insoluble cyclodextrin polymer contacted with said aqueous composition is in the form of a porous membrane or hollow fiber.

10. The process of claim 6 wherein said water insoluble cyclodextrin polymer contacted with said aqueous composition is a thin film.

11. The process of claim 7 wherein the fixed bed of particles is in a cartridge.

12. A nonlinear optical material comprising:
a defined substrate;
a thin film of a reaction product between an organic chromophore and a water insoluble cyclydextrin polymeric composition.

13. The nonlinear optical material of claim 12 wherein said water insoluble cyclydextrin polymeric composition is a reaction product of a cyclodextrin monomer and a polyfunctional crosslinker selected from the group consisting of polyisocyanates, dihalohydrocarbons, and dichloroacetylhydrocarbons.

14. The nonlinear optical material of claim 12 wherein said organic chromophore is selected from the group consisting of 4-nitrophenol, 4-nitrostyryl-4′-phenol, 4-hydroxylstilbazole, and 4-hydroxylstilbazolium iodide.
